(19) United States
(12) Patent Application Publication
(10) Pub. No.: US 2009/0063175 A1
(43) Pub. Date: Mar. 5, 2009

(54) METHODS AND SYSTEMS FOR PROVIDING MULTIPLE SUPPORT OPTIONS

(76) Inventors: Jason Hibbets, Raleigh, NC (US); Norman L. Faus, Holly Springs, NC (US)

Correspondence Address: MH2 TECHNOLOGY LAW GROUP (Cust. No. w/Red Hat), 1951 KIDWELL DRIVE, SUITE 550, TYSONS CORNER, VA, 22182, US

(21) Appl. No.: 11/848,816

(22) Filed: Aug. 31, 2007

(51) Int. Cl. G06Q 10/00; G06F 17/30; G06F 17/40

(52) U.S. Cl. 705/1

(57) ABSTRACT

An embodiment relates to a method of providing support. The method includes receiving a request for technical support. The request comprises a description of the support sought and types of support sought. The method further includes determining the types of support available based on the request and generating a list of the available types of support. The list includes a link to initiate the available types of support. The method further includes providing the list to a user requesting the support.

### FIELD

This invention relates generally to products and services, more particularly, to systems and methods for providing support for products and services.

### DESCRIPTION OF THE RELATED ART

The proliferation of the World Wide Web through the Internet has made a wealth of products and services available to users to purchase and use nearly instantaneously. Vendors, service providers, manufacturers, third party distributors, etc., may have websites for the users to review and purchase their respective products and/or services and to obtain technical support for the product and/or services.

The World Wide Web has also generated many message boards, usenet groups, forums, chat rooms, or other types of electronic discussion groups to discuss a variety of topics. Many of the topics involve technical support of a particular product (e.g., software application, hardware device, etc.).

Typically, a user contacts a technical support person in order to resolve a problem or issue with a product or service. A user can use a variety of methods to contact a technical support person, e.g., call a designated telephone number, open a chat session, send an email, etc. Typically, a support ticket is created for a particular user's particular technical problem.

The support ticket can initially contain a variety of information such as a description of the problem, i.e., a support issue, reporting user, assigned personnel, contact information, etc. As the support issue is resolved the support technician updates the support ticket with information describing how the solution was resolved. Once the support issue is resolved, the ticket and its respective solution are stored within a database of a case management system.

Under the typical method, the technician may take a significant amount of time to review the support ticket and analyze the support. Often the support person may not be the appropriate person to resolve the issue. In this case, the ticket may need to be reassigned to a different support person. As such, the user may wait a significant amount of time without learning the resolution of issue. Thus, there is a need in the art for integrating different types of technical support in order to provide the user with a quick resolution of support issues.

### BRIEF DESCRIPTION OF THE DRAWINGS

Various features of the embodiments can be more fully appreciated, as the same become better understood with reference to the following detailed description of the embodiments when considered in connection with the accompanying figures, in which:

FIG. 1 depicts an exemplary system in accordance with an embodiment.

FIG. 2 illustrates an exemplary service portal of the system shown in FIG. 1 in accordance with another embodiment.

FIG. 3 depicts an exemplary support module shown in FIG. 1 in accordance with yet another embodiment.

FIG. 4 illustrates an exemplary support request interface in accordance with yet another embodiment.

FIG. 5 illustrates an exemplary support results interface in accordance with yet another embodiment.

FIG. 6 depicts an exemplary flow diagram in accordance with yet another embodiment.

FIG. 7 depicts another exemplary flow diagram in accordance with yet another embodiment.

FIG. 8 depicts another exemplary flow diagram in accordance with yet another embodiment.

FIG. 9 depicts an exemplary computing platform in accordance with yet another embodiment.

### DETAILED DESCRIPTION OF EMBODIMENTS

For simplicity and illustrative purposes, the principles of the present invention are described by referring mainly to exemplary embodiments thereof. However, one of ordinary skill in the art would readily recognize that the same principles are equally applicable to, and can be implemented in, all types of information and service portals, and that any such variations do not depart from the true spirit and scope of the present invention. Moreover, in the following detailed description, references are made to the accompanying figures, which illustrate specific embodiments. Electrical, mechanical, logical and structural changes may be made to the embodiments without departing from the spirit and scope of the present invention. The following detailed description is, therefore, not to be taken in a limiting sense and the scope of the present invention is defined by the appended claims and their equivalents.

Embodiments relate generally to systems and methods for providing a real time and synchronous technical support by integrating multiple support resources. More particularly, a support module can be configured to receive a request from a user for technical support on a web service portal. The support module can receive the request generated from a graphical user interface of the web service portal. The request for technical support can include a description of the technical support sought and the type of support option sought.

The support module can perform a keyword search on the request to identify the subject of technical support sought. The keyword search can be based on a dictionary of terms, which can be developed by the user, vendors of the products, technical support staff or combinations thereof and based on the types of products and services, previous technical support requests, and the like. Once the subject of the technical support is determined, the support module can determine support options available to the user. The support options can be previous resolved support issues from the knowledgebase, forums discussing the technical support issues, online chat with available experts, web tickets, and combinations thereof.

If the requester chooses online chat, the support module can configure and establish the chat session with the available experts. The support module can configure and establish the chat session by searching for available experts based on the subject of the support request. The experts can be experts established by the web portal, experts established by the product vendors, users determined to be experts, and the like. Additionally, the support module can monitor the online chat session to confirm that the user resolves the technical support issue. If additional experts are required, the support module can search for another expert and facilitate the chat with the additional expert.

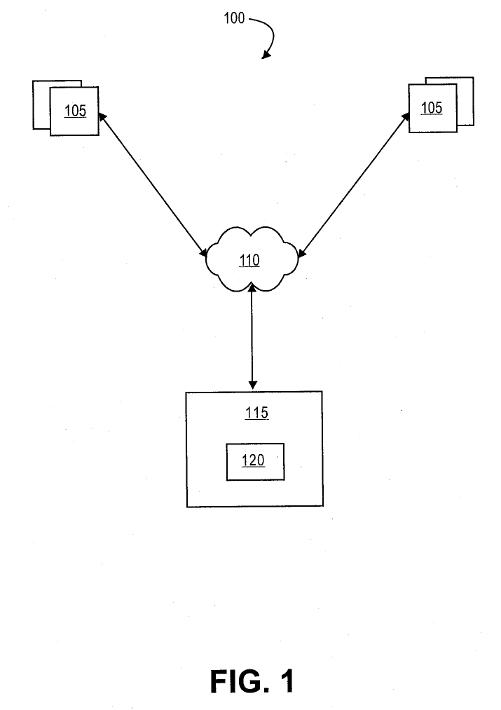

FIG. 1 illustrates an exemplary system 100 in accordance with an embodiment. It should be readily apparent to those of ordinary skill in the art that system 100 depicted in FIG. 1 represents a generalized schematic illustration and that other components may be added or existing components may be removed or modified. Moreover, system 100 may be implemented using software components, hardware components, or combinations thereof.

As shown in FIG. 1, system 100 includes users 105, a network 110 and a web service portal 115. Users 105 can be private individuals, employees of private business or public entities or other persons interested in accessing web service portal 115. Users 105 can access web service portal 115 using personal computers, personal mobile devices, workstations or other networked computing platforms.

Network 110 can be a combination of wide area and local area networks such as the Internet. Network 110 can be configured to provide a communication channel between users 105 and web service portal 115. Network 110 can implement a variety of network protocols to provide the communication channel such as Internet Protocol (“IP”) Vx, ATM, SONET, or other similar network protocols.

Web service portal 115 can be configured to provide products and services to user 105 as well as provisioning, installation services, updates to software and hardware products and technical support. Web service portal 115 can, among other functions, provide a list of products such as software applications and/or hardware devices as well as services such as installation, configuration, maintenance, etc., for users 105 to purchase. As a non-limiting example, web service portal 115 can also provide information for users to research, compare and purchase software, hardware and consulting services in support of those software and/or hardware purchases. Web service portal 115 can also be configured to provide support services, for free or by subscription, to those same software, service, and/or hardware purchases.

In accordance with various embodiments, web service portal 115 can be configured to provide a support module 120 to provide integrated and seamless technical support for products being sold on web service portal 115. More specifically, support module 120 can be configured to receive a request from a user for technical support on a web service portal. Support module 120 can receive the request from a graphical user interface of the web service portal. The request for technical support can include a description of the technical support sought and the type of support option sought.

Support module 120 can perform a keyword search on the request to identify the subject of the desired technical support sought. The subject can be the technical area, in which the issue or problem that the user is requesting support, can be classified. The keyword search can be based on a dictionary of terms, which can be developed by the user, vendors of the products, technical support staff or a combinations thereof and based on the types of products and services, previous technical support requests, and the like. Once the subject of the technical support is determined, support module 120 can determine the support options available to the user. Support options 120 can be previous resolved support issues from the knowledgebase, forums discussing the technical support issues, online chat with available experts, web tickets, and combinations thereof.

If the requester chooses online chat, support module 120 can configure and establish the chat session with the available experts. Support module 120 can configure and establish the chat session by searching for available experts based on the subject of the support request. The experts can be experts established by the web portal, experts established by the product vendors, users determined to be experts, and the like. Additionally, support module 120 can monitor the online chat session to confirm that the user resolves the technical support issue. If additional experts are required, support module 120 can search for another expert and facilitate the chat with the additional expert.

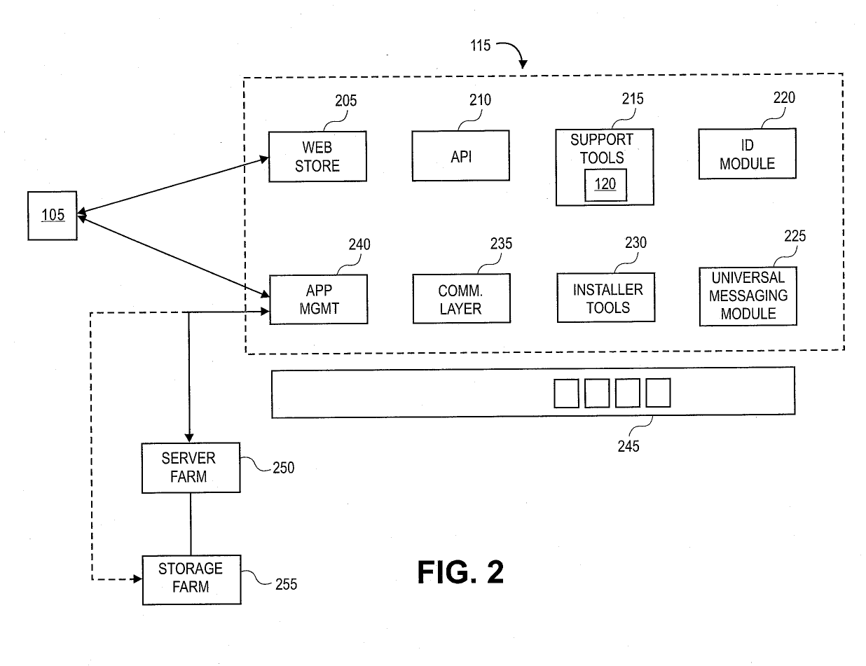

FIG. 2 illustrates a more detailed block diagram of web service portal 115 in accordance with another embodiment. It should be readily apparent to those of ordinary skill in the art that web service portal 115 depicted in FIG. 2 represents a generalized schematic illustration and that other components may be added or existing components may be removed or modified.

As shown in FIG. 2, web service portal 115 can include a web store module 205 that a user can interface with the service portal. Web store module 205 can provide the graphical user interfaces (“GUIs”) and associated functions and/or services for web service portal 115. As a non-limiting example, web store module 205 can generate a log-in GUI for a user to authenticate and enter web service portal 115.

Web store module 205 can couple with an application program interface (“API”) module 210. API module 210 can be configured to provide an interface between the functions and/or services provided by web store module 205 and to the appropriate module of web service portal 115. More particularly, API module 210 can call or direct a requested function or service from the user to the respective module that provides that requested function or service. For example, a user may request a price of a product, e.g., product vending module, API module 210 can direct the request to a get price function in a support tools module 215.

API module 210 can also be configured to interface with support tools module 215. Support tools module 215 can be configured to provide the supporting software and hardware to implement the functionality of web service portal 115. Support tools module 215 can contain and provide access to databases that contain information such as products lines, services providers, on-line self-help (e.g., knowledgebase), etc. Support tools module 215 can also provide services like a chat services, a help desk, installation, provisioning, etc.

API module 210 can be further configured to couple with an identification (“ID”) module 220. ID module 220 can be configured to provide identification management services for web service portal 115. ID module 220 can also store information related to users such as purchase history, user profile, usage history of the user, and entitlement data.

API module 210 can be further configured to couple with a universal messaging module 225. Universal messaging module 225 can be configured to provide a messaging application that unifies messages. More specifically, electronic mail (“email”), documents, and instant messaging can be linked in a single application. Universal messaging module 225 can also provide a mechanism for a user to view all the related documents for the user from email to Wiki pages.

An installer tools 230 can be coupled to API module 210. One of the services provided by web service portal 115 can be the purchase of software applications provided by independent software vendors (“ISVs”). As part of the delivery of the software applications, the ISV can be required to maintain and update the installation tools to install their respective software applications. Accordingly, installer tools 230 can be a repository where independent software vendors can deposit their respective installation tools.

API module 210 can be further coupled to a communication layer 235 (labeled as COMM layer in FIG. 2). Communication layer 235 can be configured to provide the underlying services for the modules of web service portal 115 to communicate. For example, communication layer 235 can contain middleware for a product database to communicate with a graphical user interface requesting product description.

API module 210 can be further coupled to an application management module 240 (labeled as APP MGMT in FIG. 2). Application management module 240 can be configured to manage applications as requested by users. More specifically, a user may purchase a prepackaged software application pack (e.g., an operating system, electronic mail program and data mining program) from web service portal 115, which is stored in an application stack module 245. Application management module 240 can then deliver the purchased software stack, install and configure the software application stack at a third party site such as server farm 250 or store the software application stack in a storage farm 255 for the user to retrieve.

Server farm 250 can be configured to provide computing platforms for users to lease. Accordingly, users can have a backup version of their systems, a testing platform to perform quality assurance tests on new applications, execute a program requiring excessive MIPS, or any other similar computing task.

Storage farm 255 can be configured to provide storage space for users to lease. Accordingly, users can lease disk storage space to back up data, provide a hot data swap, or other storage intensive tasks.

In some embodiments, support module 120 can be configured to be executed in support tools module 215. In other embodiments, support module 120 can be executed as a standalone module.

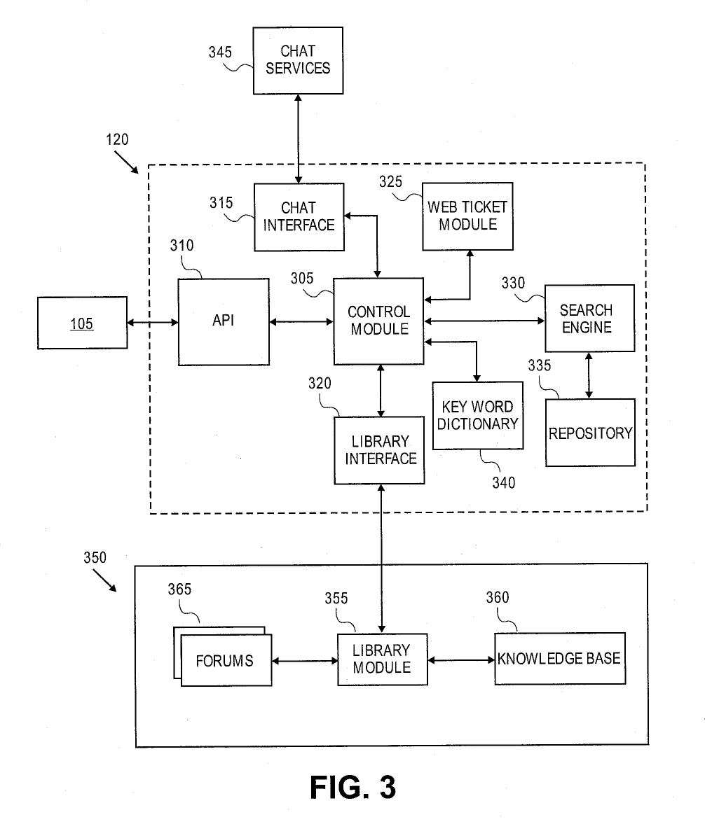

FIG. 3 depicts a more detailed block diagram of support module 120 in accordance with another embodiment. It should be readily apparent to those of ordinary skill in the art that support module 120 depicted in FIG. 3 represents a generalized schematic illustration and that other components may be added or existing components may be removed or modified.

As shown in FIG. 3, support module 120 can comprise a control module 305, an application program interface (“API”) 310, a chat interface 315, a library interface 320, a web ticket module 325, a search engine 330, a registry 335, and a keyword dictionary 340. It should be readily obvious to one of ordinary skill in the art that the modules 305-340 can be implemented as software applications (programmed in C, C++, JAVA, PHP, etc.), hardware components (EEPROM, application specific integrated circuit, microprocessor, etc.) or combinations thereof.

The control module 305 can be configured to manage and interface with the other modules 310-340 to provide the functionality of the support module 120 as described above and further described herein below. Additionally, control module 305 can be configured to interface with other modules such as chat services 345 and knowledge library 350 as described above and further described herein below.

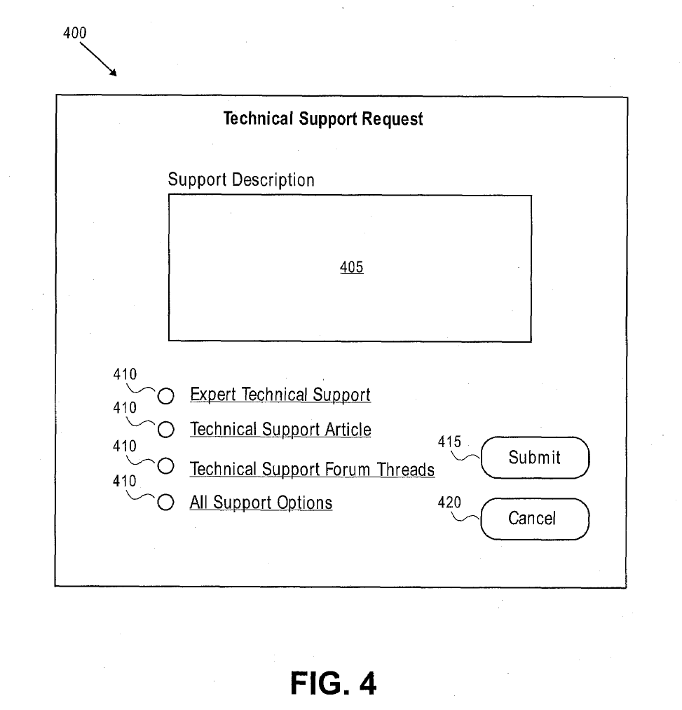

API 310 can be configured to generate GUIs, e.g. web pages, as required by control module 305. For example, API 310 can be configured to generate a support request interface to allow a user to request a technical support option or all available support options. API 310 can be configured to generate the support request interface to allow the user to describe the subject of the technical support sought and specific the support option requested. An exemplary support request GUI is shown in FIG. 4.

FIG. 4 depicts an exemplary support request GUI 400 in accordance with yet another embodiment. It should be readily apparent to those of ordinary skill in the art that the support request GUI 400 depicted in FIG. 4 represents a generalized schematic illustration and that other components may be added or existing components may be removed or modified. Moreover, the connection option GUI 400 can be implemented using languages such as VisualBasic, Visual C++, Extensible Markup Language, PHP, Java, or other similar languages.

As illustrated, GUI 400 can be configured to include a description text field 405, support option selection widgets 410, a submit widget 415 and a cancel widget 420. Description text field 405 can be an editable text field in which the user can enter a description of the subject of the support sought. Support option selection widgets 410 can be configured to allow the user to select one or more support option sought.

Submit widget 415 can be configured to allow the user to submit the request to control module 305. Cancel widget 420 can be configured to allow the user to cancel the request.

Returning to FIG. 3, control module 305 can be configured to receive the user's request for technical support, for example from GUI 400, and determine the requested support options or all available support options. To achieve this, control module 305 can be coupled to keyword dictionary 340. Keyword dictionary 340 can contain a list of keywords describing various type of technical support issues. The keywords can be established by support experts, users' of the service portal 115, product vendors, and the like. Additionally, the keywords can be based on previous technical support issues or anticipated support issues. Control module 305 can perform a keyword search to compare the description provided in the request interface with the keywords.

From this, control module 305 can determine the subject of the technical support sought based on matching keywords. The subject can be the technical area, in which the issue or problem that the user is requesting support, can be classified. For example, if a user is requesting technical support on installing Mozilla Firefox Browser, the subject can be Firefox program support and installation.

To determine available support options, control module 305 can also be coupled with search engine 330 and registry 335. Registry 335 can store a list support experts designated by service portal 115, experts designated by product vendors, and the users of the user community of service portal 115 that desire to be recognized as a technical expert in a selected technical field and are willing to assist other users (collectively referred to as “experts”). Registry 335 can store the username of the expert and can store information on the expert, such as expertise field, association, and availability. Control module 335 can then request the information regarding a support user in registry 335 from an associated user profile stored in the ID module 220. Registry 335 can be implemented using a database as known to those skilled in the art.

Registry 335 can be coupled to search engine 330. Search engine 330 can be configured to allow control module 305 to search for experts in registry 335 in a technical area similar to the subject of the technical support sought. Search engine 330 can be configured to return the search results from a received query to control module 305 for further processing.

Once experts have been identified, control module 305 can be configured to establish communications with the expert. To achieve this, control module 305 can be coupled to chat interface 315. Chat interface 315 can be configured to provide an interface to chat services 345. Control module 305 can be configured to request and establish a chat session with an expert in response to a user selecting to speak with the expert. Additionally, control module 305 can be configured to monitor established chats and to receive requests for additional experts.

Also, control module 305 can be coupled to web ticket module 325. Web ticket module 325 can be configured to generate a web ticket in response to a user selecting a expert who is not available for a chat session. Web ticket module 325 can be configured to store the web ticket and communicate the web ticket to the respective expert.

Additionally, control module 305 can be coupled to a knowledge library interface 320. Knowledge library interface 320 can be configured to couple with a library 350 as required by control module 305 to search for technical support information. Library interface 320 can also be configured to retrieve a content from knowledge library 350.

Knowledge library 350 can be configured to provide a support and knowledge library of the service portal 115. The knowledge library 350 can comprise a library module 355, a knowledgebase 360, and forums 365. Library module 355 can be configured to provide control for the modules of knowledge library 350 and for interface with other modules. Knowledgebase 360 can contain Wiki-style articles regarding products, known issues, and solutions. Knowledgebase 360 can also contain frequently asked questions. Knowledgebase 360 can be implemented in a database(s) or the like.

Knowledge library 350 can further be configured to couple library module 355 to forums 365. A forum can be regarded as essentially a website composed of a number of member-written threads. Each thread entails a discussion or conversation in the form of a series of user-member written posts about topics such as technical support. These threads remain saved on the forum website for future reading indefinitely or until deletion by a moderator.

Software packages that implement forum websites are generally well known. These software packages are widely available on the Internet in a variety of programming languages such as HypeterText Preprocess (“PHP”), Perl, Java, and active server pages (“ASP”). The configuration and records of posts can be stored in text files or in a database.

Control module 305 can be configured to forward the subject of the technical support desired to knowledge library 350. Library module 355 can be configured to receive the request and search the knowledge base 360 for articles similar to the subject of the desired technical support. Library module 355 can also be configured to search forums 365 for threads matching the subject of the desired technical support. Library module 355 can be configured to provide a list of knowledgebase articles and forums matching the subject of the desired technical support. The list can include links to the articles and forums.

Control module 305 can also be configured to compile all the available technical support options and present the technical support options to the requesting user. For example, API 310, in response to control module 305, can generate a support result interface that displays a list of available support types including a links to initiate the support option.

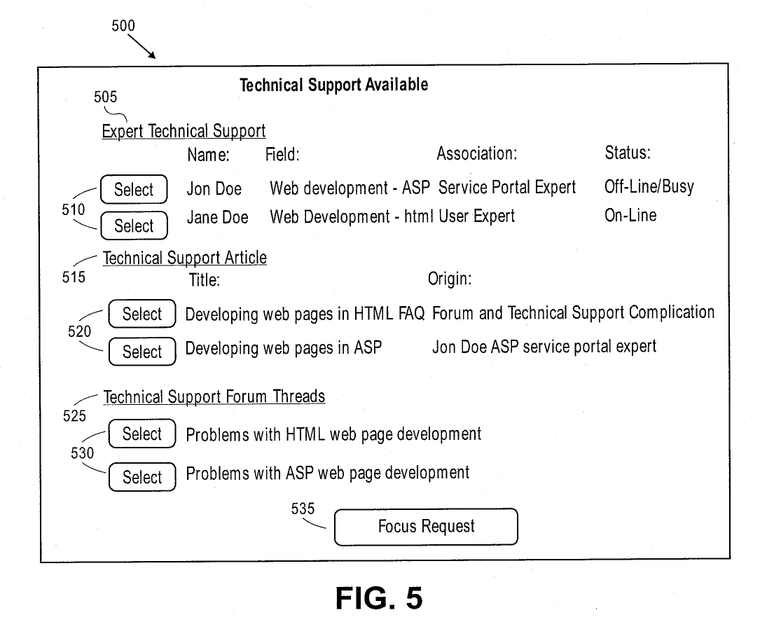

FIG. 5 is a diagram illustrating an exemplary support results GUI 500 in accordance with yet another embodiment. It should be readily apparent to those of ordinary skill in the art that the support results GUI 500 depicted in FIG. 5 represents a generalized schematic illustration and that other components may be added or existing components may be removed or modified.

As illustrated, GUI 500 can be configured to include an expert technical support section 505. Expert technical support section 505 displays any experts that match the subject of the technical support requested. Expert technical support section 505 can include the name of the expert, technical support field of the expert, association of the expert, and availability status of the expert. Additionally, expert technical support section 505 can be configured to include widgets 510 to allow the user to select an expert. Widgets 510 can initiate contact with the expert by providing a link to request control module 305 initiate contact with the expert.

GUI 500 can be configured to include a technical support article section 515. Technical support article section 515 displays any articles that match the subject of the technical support requested. Technical support article section 515 can include the title of the article and the origin of the article. Additionally, technical support article section 515 can be configured to include widgets 520 to allow the user to select an article. Widgets 520 can configured to provide a link to the article.

GUI 500 can be configured to include a technical support forum section 525. Technical support forum section 525 displays any forum threads that match the subject of the technical support requested. Technical support forum section 525 can include the title of the forum thread. Additionally, technical support forum section 525 can be configured to include widgets 530 to allow the user to select a forum thread. Widgets 530 can configured to provide a link to the forum.

Additionally, GUI 500 can include a focus request widget 535. Focus request widget 535 can be configured to allow the user to provide more information about the subject of the technical support in the event that the options do not match the subject of the technical support. For example, focus request widget 535 can initiate control module 305 to re-generate GUI 400.

Returning to FIG. 3, control module 305 can be configured to receive request for support from other sources. For example, control module 305 can be configured to receive request for support for chat services 345 and forums 365. Control module 305 can handle the request for support and determine support options as described above.

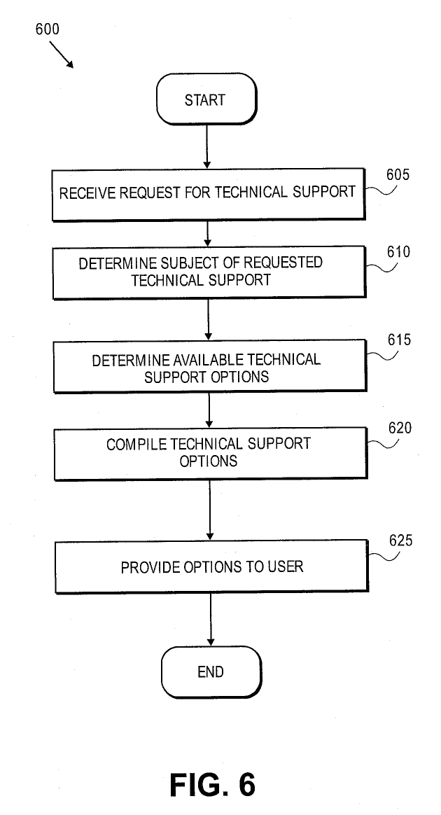

FIG. 6 illustrates a flow diagram 600 for requesting technical support from support module 120 in accordance with yet another embodiment. It should be readily apparent to those of ordinary skill in the art that the flow diagram 600 depicted in FIG. 6 represents a generalized schematic illustration and that other steps may be added or existing steps may be removed or modified.

As shown in FIG. 6, control module 305 can be configured to receive a request for technical support, in step 605. More particularly, control module 305 can be configured to receive a request for support through a GUI, such as GUI 400, or other module such as chat services 345 or forums 365.

In step 610, control module 305 can be configured to determine the subject of the technical support requested. More specifically, control module 305 can perform a keyword search to compare the description provided in the request with the keywords in keyword dictionary 340. Control module 305 can determine the subject of the technical support sought based on the matching keywords.

In step 615, control module 305 can be configured to determine available technical support options. More particularly, control module 305 can search repository 335 to determine experts that match the subject of the request. Control module 305 can also request a search of knowledge library 350 to determine any forums or articles matching the subject of the request. Control module 305 can determine one or more of these options depending on whether the user requested a specific support option or all available options.

Then, control module 305 can be configured to compile all the determined support options, in step 620. Control module 305 can be configured to provide the available options to the user, in step 625. More specifically, control module 305 can generate a GUI, such as GUI 500, to contain the available options and provide a mechanism for the user to select the options.

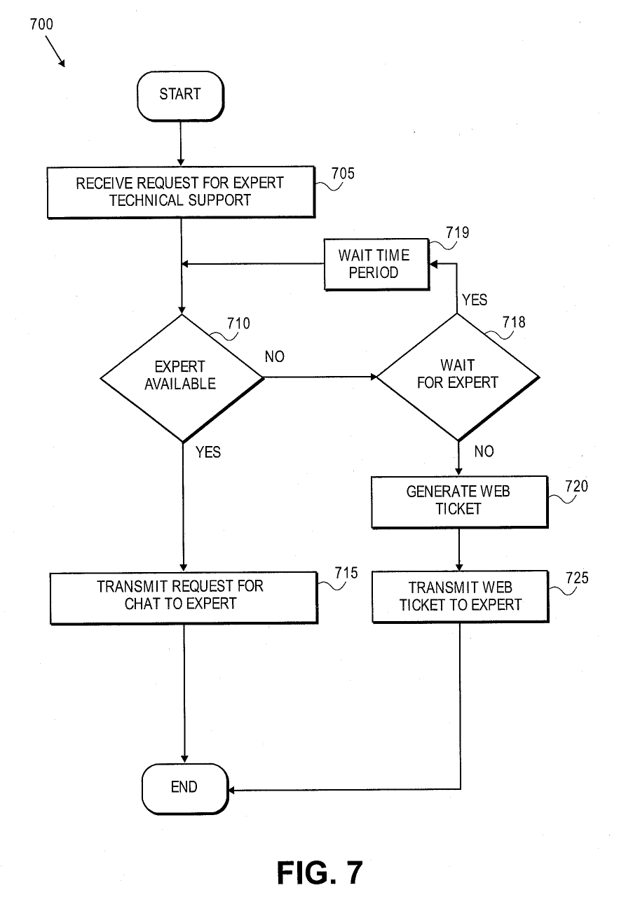

FIG. 7 illustrates a flow diagram 700 for initiating contact with an expert in accordance with yet another embodiment. It should be readily apparent to those of ordinary skill in the art that the flow diagram 700 depicted in FIG. 7 represents a generalized schematic illustration and that other steps may be added or existing steps may be removed or modified.

As shown in FIG. 7, control module 305 can be configured to receive a request for expert support, in step 705. More particularly, control module 305 can receive notification from GUI 500 that the user has selected a particular expert.

In step 710, control module 305 can be configured to determine if the selected expert is available for immediate communication with the user. More particularly, control module 305 can query repository 335 to determine if the selected expert is online and available for chat.

If the expert is immediately available, control module 305 can be configured to transmit the request for chat to the expert, in step 715. More specifically, control module 305 can transmit the request via chat interface 315 to chat services 345. The chat services 345 can place the request in a chat queue of the expert and can control the chat between the user and expert.

If the expert is not immediately available, control module 305 can be configured to allow the user to choose to wait a period of time for the expert to become available, in step 718. For example, the expert can be online but busy assisting other users. If the user chooses to wait, control module 305 can be configured to wait a time period for the expert to become available, in step 719. Control module 305 can wait a predetermined period of time or a period of time specified by the user. After the period of time, control module 305 can be configured to determine if the expert is available, as in step 710.

If the user chooses not to wait, control module 305 can be configured to generate a web ticket, in step 720. More specifically, control module 305 can request web ticket module 325 to generate a web ticket with the user's support request.

In step 725, web ticket module 325 can be configured to transmit the web ticket to the expert. More particularly, web ticket module 325 can utilize universal messaging module 225 to transmit the web ticket to the expert.

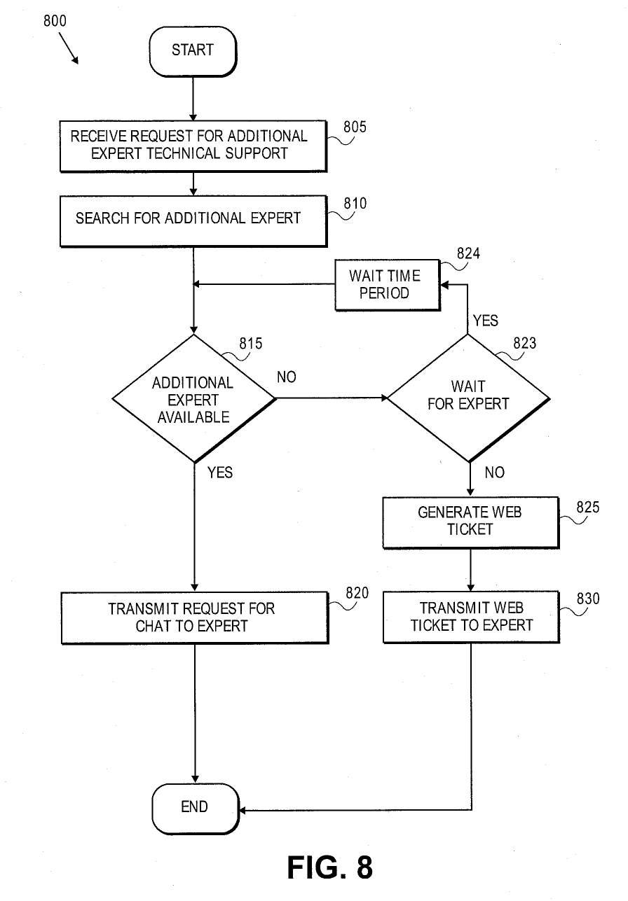

FIG. 8 illustrates a flow diagram 800 for monitoring chats and determining additional experts in accordance with yet another embodiment. It should be readily apparent to those of ordinary skill in the art that the flow diagram 800 depicted in FIG. 8 represents a generalized schematic illustration and that other steps may be added or existing steps may be removed or modified.

As shown in FIG. 8, once chat is initiated between the user and selected expert, the expert or user can determine that an additional expert is needed. In step 805, control module can be configured to receive a request for an additional expert from the user or expert. The request may include information of the technical support required.

In step 810, control module 305 can be configured to search for an additional expert. More particularly, control module 305 can perform a search as described above in FIG. 6.

In step 815, control module 305 can be configured to determine if an additional expert is available. More particularly, control module 305 can review the list of additional experts and determine if one of the experts is available.

If an expert is immediately available, control module 305 can be configured to transmit the request for chat to the expert, in step 820. More specifically, control module 305 can transmit the request via chat interface 315 to chat services 345. The chat services 345 can place the request in a chat queue of the expert and can control the chat between the user and expert.

If any additional experts are not immediately available, control module 305 can be configured to allow the user to choose to wait a period of time for the expert to become available, in step 823. For example, the expert can be online but busy assisting other users. If the user chooses to wait, control module 305 can be configured to wait a time period for the expert to become available, in step 824. Control module 305 can wait a predetermined period of time or a period of time specified by the user. After the period of time, control module 305 can be configured to determine if the additional expert is available, as in step 815.

If the user chooses not to wait, control module 305 can be configured to generate a web ticket, in step 825. More specifically, control module 305 can request web ticket module 325 to generate a web ticket with the user's support request.

In step 830, web ticket module 325 can be configured to transmit the web ticket to the expert. More particularly, web ticket module 325 can utilize universal messaging module 225 to transmit the web ticket to the expert.

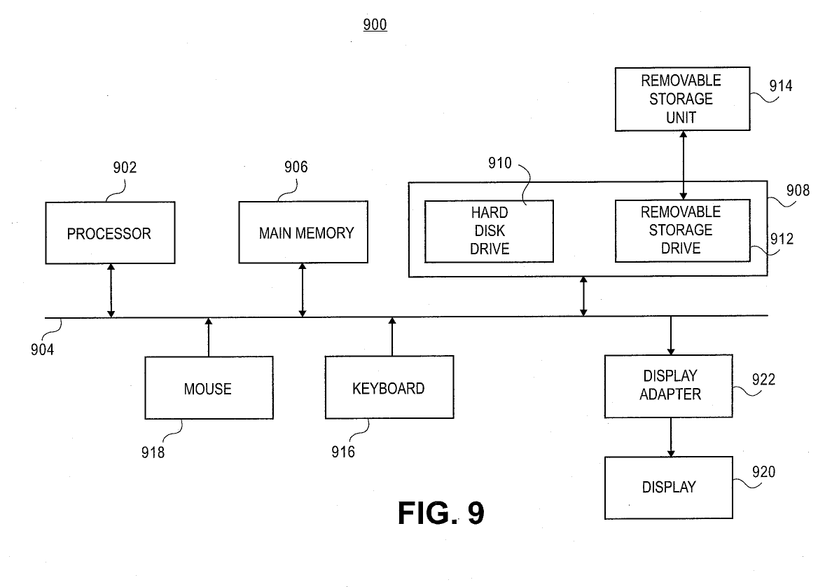

FIG. 9 illustrates an exemplary block diagram of a computing platform 900 where an embodiment may be practiced. The functions of the support module 120 can be implemented in program code and executed by computing platform 900. Support module 130 may be implemented in computer languages such as PASCAL, C, C++, JAVA, etc.

As shown in FIG. 9, computing platform 900 includes one or more processors, such as processor 902 that provide an execution platform for embodiments of support module 120. Commands and data from processor 902 are communicated over a communication bus 904. Computing platform 900 also includes a main memory 906, such as a Random Access Memory (RAM), where support module 120 can be executed during runtime, and a secondary memory 908. Secondary memory 908 includes, for example, a hard disk drive 910 and/or a removable storage drive 912, representing a floppy diskette drive, a magnetic tape drive, a compact disk drive, etc., where a copy of a computer program embodiment for support module 120 can be stored. Removable storage drive 912 reads from and/or writes to a removable storage unit 914 in a well-known manner. A user interfaces with the support module 120 with a keyboard 916, a mouse 918, and a display 920. Display adapter 922 interfaces with the communication bus 904 and display 920. Display adapter 922 also receives display data from processor 902 and converts the display data into display commands for display 920.

Certain embodiments may be performed as a computer program. The computer program may exist in a variety of forms both active and inactive. For example, the computer program can exist as software program(s) comprised of program instructions in source code, object code, executable code or other formats; firmware program(s); or hardware description language (HDL) files. Any of the above can be embodied on a computer readable medium, which include storage devices and signals, in compressed or uncompressed form. Exemplary computer readable storage devices include conventional computer system RAM (random access memory), ROM (read-only memory), EPROM (erasable, programmable ROM), EEPROM (electrically erasable, programmable ROM), and magnetic or optical disks or tapes. Exemplary computer readable signals, whether modulated using a carrier or not, are signals that a computer system hosting or running the present invention can be configured to access, including signals downloaded through the Internet or other networks. Concrete examples of the foregoing include distribution of executable software program(s) of the computer program on a CD-ROM or via Internet download. In a sense, the Internet itself, as an abstract entity, is a computer readable medium. The same is true of computer networks in general.

While the invention has been described with reference to the exemplary embodiments thereof, those skilled in the art will be able to make various modifications to the described embodiments without departing from the true spirit and scope. The terms and descriptions used herein are set forth by way of illustration only and are not meant as limitations. In particular, although the method has been described by examples, the steps of the method may be performed in a different order than illustrated or simultaneously. Those skilled in the art will recognize that these and other variations are possible within the spirit and scope as defined in the following claims and their equivalents.

What is claimed is:

1. A method of providing support, the method comprising:
receiving a request for technical support, the request comprising a description of the support sought and types of support sought;
determining the types of support available based on the request;
generating a list of the available types of support, the list including a link to initiate the available types of support; and
providing the list to a user requesting the support.

2. The method of claim 1, wherein determining the types of support available comprises:
performing a keyword search on the description of the support sought to determine a subject of the support sought.

3. The method of claim 2, further comprising:
determining experts with technical expertise in the subject of the support sought.

4. The method of claim 3, further comprising:
determining articles related to the subject of the support sought;
determining forum threads related to the subject of the support sought; and
compiling the determined experts, determined articles, and determined forum threads as the list.

5. The method of claim 3, further comprising:
receiving a request to initiate communication with at least one of the determined experts;
determining an availability of the at least one of the determined experts; and
transmitting a request for a chat if the at least one of the determined expert is available.

6. The method of claim 5, further comprising:
receiving a request for at least one additional expert with expertize in the subject of the support sought;
determining an availability of the at least one additional expert; and
transmitting a request for a chat if the at least one additional expert is available.

7. An apparatus for providing technical support, the apparatus comprising:
a program interface adapted to receive requests for technical support, the request comprising a description of the support sought and types of support sought;
a keyword dictionary, the keyword dictionary comprising a set of keyword terms; and
a control module coupled to the program interface and keyword dictionary, the control module configured to determine the types of support available based on the request; to generate a list of the available types of support, the list including a link to initiate the available types of support; and to provide the list to a user requesting the support.

8. The apparatus of claim 7, wherein the control module is further configured to compare keywords to the description of the support sought and to determine a subject of the support sought.

9. The apparatus of claim 8, further comprising:
a repository adapted to store a list of experts;
a search engine coupled to the repository and control module, the search engine configured to determine experts in the repository with technical expertize in the subject of the support sought.

10. The apparatus of claim 9, wherein the control module is further configured to determine articles related to the subject of the support sought; to determine forum threads related to the subject of the support sought; and to compile the determined experts, determined articles, and determined forum threads as the list.

11. The apparatus of claim 9, wherein the control module is further configured to receive a request to initiate communication with at least one of the determined experts; to determine an availability of the at least one of the determined experts; and to transmit a request for a chat if the at least one of the determined expert is available.

12. The apparatus of claim 11, wherein the control module is further configured to receive a request for at least one additional expert with expertize in the subject of the support sought; to determine an availability of the at least one additional expert; and to transmit a request for a chat if the at least one additional expert is available.

13. A system for developing providing support, the system comprising:
a network configured to provide a communication channel for a plurality of users; and
a web service portal coupled to the network and configured to provide products and services to the plurality of users, wherein the web-service portal further comprises:
a program interface adapted to receive requests for technical support, the request comprising a description of the support sought and types of support sought;
a keyword dictionary, the keyword dictionary comprising a set of keyword terms; and
a control module coupled to the program interface and keyword dictionary, the control module configured to determine the types of support available based on the request; to generate a list of the available types of support, the list including a link to initiate the available types of support; and to provide the list to a user requesting the support.

14. The system of claim 13, wherein the control module is further configured to compare keywords to the description of the support sought and to determine a subject of the support sought.

15. The system of claim 14, wherein the web service portal further comprises:
a repository adapted to store a list of experts;
a search engine coupled to the repository and control module, the search engine configured to determine experts in the repository with technical expertise in the subject of the support sought.

16. The system of claim 15, wherein the web service portal further comprises:
a knowledge library adapted to maintain articles related to technical support and adapted to maintain forums related to technical support; and
wherein the control module is further configured communicate with the knowledge library to determine articles related to the subject of the support sought; to determine forum threads related to the subject of the support sought; and to compile the determined experts, determined articles, and determined forum threads as the list.

17. The system of claim 15, wherein the web service portal further comprises:
a chat services module adapted to provide chat services; and
wherein the control module is further configured to communicate with the chat services module and to receive a request to initiate communication with at least one of the determined experts; to determine an availability of the at least one of the determined experts; and to transmit a request for a chat to the chat services if the at least one of the determined expert is available.

18. The system of claim 17, wherein the control module is further configured to receive a request from the chat services module for at least one additional expert with expertize in the subject of the support sought; to determine an availability of the at least one additional expert; and to transmit a request for a chat to the chat services module if the at least one additional expert is available.
